(19) United States
(12) Patent Application Publication
(10) Pub. No.: US 2008/0240017 A1
(43) Pub. Date: Oct. 2, 2008

(54) Method and apparatus of establishing connection in wireless local area network

(76) Inventors: Oren Kaidar, Binyamina (IL); Izoslav Tchigevsky, Kiryat Haim (IL)

Correspondence Address: PEARL COHEN ZEDEK LATZER, LLP, 1500 BROADWAY, 12TH FLOOR, NEW YORK, NY, 10036, US

(21) Appl. No.: 11/727,400

(22) Filed: Mar. 26, 2007

(51) Int. Cl. H04Q 7/00

(52) U.S. Cl. 370/328

(57) ABSTRACT

An access point and a method to discover an associated station in a wireless network is presented. The access point scans the wireless network in order to discover one or more associated stations and establishes a connection with the discovered station.

### BACKGROUND OF THE INVENTION

Wireless local area networks (WLAN) may include a basic service set (BSS). The BSS may include an access point (AP) and one or more stations (STA) Mobile Devices such as, for example notebooks or ultra-mobile PC may implement 802.11 AP functionality and serve as a mobile AP.

A personal area network (PAN) is a computer network used for communication among computer devices (for example, telephones and personal digital assistants) close to one person. The devices may or may not belong to the person in question. The reach of a PAN may be a few meters. PANs may be used for communication among the personal devices themselves (intrapersonal communication), or for connecting to a higher level network and the Internet (an uplink). Personal area networks may be wired with computer buses such as universal serial bus (USB) and FireWire. A wireless personal area network (WPAN) may use wireless network technologies such as, for example IrDA and Bluetooth.

A connection between WLAN and WPAN may be done by a WLAN station that is capable of becoming a mobile AP and/or a PAN Master device. Such Mobile AP may frequently changes environment and is not always available to be discovered by the clients as is done with a fixed AP.

For example, a PAN Master device (e.g., the mobile AP) enters a room with a projector, which includes a WLAN transceiver, and wishes to establish a WLAN network with the projector to project a presentation. According to the current IEEE 802.11 standard, the projector may utilize a discovery mechanism to discover the Mobile AP and establishes the connection with the mobile AP. However, if the mobile AP is a battery operated device that may become inactive or leave the room, the projector may not be successful in discovering the mobile AP.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be under stood by reference to the following detailed description when read with the accompanied drawings in which:

FIG. 1 is a schematic illustration of a plurality of wireless communication networks according to exemplary embodiments of the present invention;

FIG. 2 is a schematic illustration of a flowchart of a method of a mobile AP connection establishment procedure according to some exemplary embodiment of the present; and

FIG. 3 is a schematic illustration of a block diagram of a mobile access point (AP) according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although ate not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

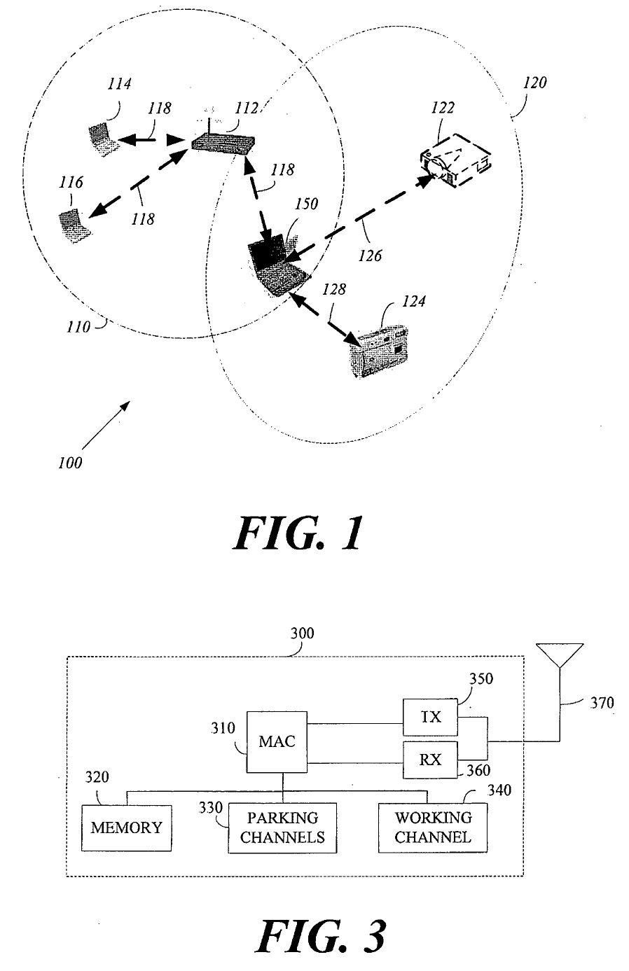

Turning first to FIG. 1, a schematic illustration of a plurality of wireless communication networks 100 according to exemplary embodiments of the present invention is shown. Although the scope of the present invention is not limited in this respect, plurality of wireless communication networks 100 may include a WLAN 100, a PAN 120 and a mobile AP 150.

According to some embodiments of the present invention, WLAN 110 may be defined by IEEE 802.11-1999 standard, as a Basic Service Set (BSS). For example, the BSS may include fixed AP 112, stations 114 and 116, mobile AP 150 and BSS channels 118, although it should be understood that exemplary WLAN 120 is not limited to this example and other WLAN configurations may be used with embodiments of the present invention.

According to exemplary embodiments of the invention, PAN 120 may be defined by IEEE 802.15-2002 standard, and includes stations 122 and 124, mobile AP 150 which may be used as a PAN master device, a parking channel 126 and a parking channel 128.

According to this exemplary embodiment of the present invention, mobile AP 150 may enter a room with stations 122 and 124. For example, station 122 may be a projector and wishes to establish a WiFi network to project presentation, if desired. According to this example, mobile AP 150 is operates as PAN master device and may operate a discovery mechanism in order to discover station 122 (e.g., the projector). Once the discovery phase is completed, mobile AP 150 may activate network establishment mechanism (e.g., triggered association mechanism) to the projector (e.g., station 122) to connect to PAN network 120.

According to some exemplary embodiments of the invention, stations 122 and 124 may advertise their parking channel 126 and 128, respectively, to mobile AP 150. The parking channel is the channel in which un-associated clients want to be discovered. For example, station 122 may park and wait for receive beacons from mobile AP 150. Station 122 may be continuously in a receive mode and/or may be awake for certain percentage of their time. Furthermore, the parking channel may be used by discovered client devices (e.g., stations 122 and/or 124) to wait for association triggered by mobile AP 150.

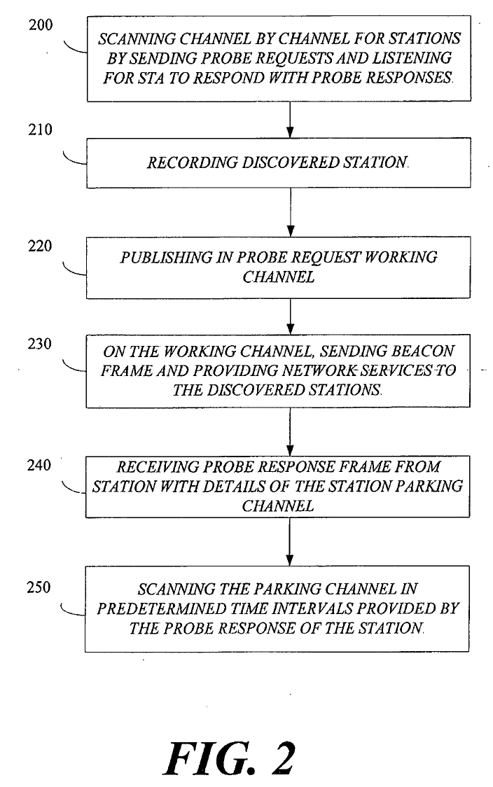

Turning to FIG. 2, a schematic illustration of a flowchart of a method of a mobile AP connection establishment procedure according to some exemplary embodiment of the present is shown. Although the scope of the present invention is not limited to this exemplary embodiment of the invention, a PAN Master device (e.g., mobile AP 150) may wish to establish connection with other PAN devices (e.g. stations (STA) 122 and 124).

According to embodiments of the present invention, the PAN Master device may scan channel by channel of the WLAN in order to discover the PAN devices (e.g., STAs). For example, the PAN Master device may send a probe request frame and listens for a probe response frame from the PAN stations (text block 200). After receiving the probe response flame, the PAN Master station may record the discovered PAN device (text block 210). For example, the discovered PAN device may be stored at a discovered station list, if desired

According to some embodiments of the invention, a mobile AP and/or the PAN Master device may publish in the probe request flame its working channel. For example, a channel according to definitions of IEEE 802.11 standard, where the mobile AP and/or a fix AP may send Beacon frames and provides other services according to IEEE 802.11 standard, if desired (text block 230). The stations may use the working channel information to initiate association with AP either automatically or on user request, if desired.

According to embodiments of the present invention, the stations may publish in a probe response frame details of its parking channel (e.g., parking channels 126, 128). The mobile AP may receive the parking channel information within the probe response frame (text block 240) and may use this information to initiate a connection with the discovered station and/or PAN device.

Furthermore, the station and/or the PAN device may declare partial presence in its parking channel. The station may set in the probe response frame a certain pattern to the park channel availability, for example, the station may be available for 50 mili-second (MSec) every 500 MSec. The timing availability may be sent in the same timing values as a time sync function (TSF) values (as it defined in IEEE 802.11 standard) in the probe request. For example, the station and/or the PAN device may receive the probe request with TSF value of x, while its own TSF value is y. Accordingly, the availability time of the station in the parking channel is y+d, therefore the probe response may include the value of: (x−y)+(y+d)→x+d, wherein d is the time delta between the AP time and time reported by device at the moment when it receives at the AP. The mobile AP may scan the parking channel in the predetermined time intervals provided in the probe response of the station (text box 250).

According to another embodiment of the invention, in order to reduce the mobile AP scanning time, there may be a set of predefined parking channels such as, for example, channel 1 in 2.4 GHz band and channel 36 in 5.2 GHz band. The predetermined parking channels may be defined by a stock keeping Units (SKU) of the network interface card (NIC) of the mobile AP and/or the stations. It should be understood that the SKU is a number that relates to as a set of frequency bands and other NIC parameters according to each country regulation. The SKU may be used by the stations as default parking channels.

According to some other embodiments of the invention, the mobile AP may perform the scanning operation as a combination of probe requesting over the predefined parking channels and probe requesting over the other channels. Although the scope of the present invention is not limited in this respect, the mobile AP and/or the PAN master device may establish a connection with stations by sending a probe request to the station in the parking channel according to the timing availability of the station at the parking channel. The probe response may include an indication requesting the station to connect to the mobile AP. It also contains AP working Channel details. The station may switch to the mobile AP working channel and starts standard 802.11 association sequence.

Turning to FIG. 3, a schematic illustration of a block diagram of an access point (AP) 300 according to exemplary embodiments of the invention of the present invention is shown. Although the scope of the present invention is not limited to this respect, access point 300 may include for example a mobile AP, a PAN master device and the like. An exemplary AP 300 may include a medium access controller (MAC) 310, a memory 320, one or more of parking channels 330, one or mote working channel 340, a transmitter (TX) 350, a receiver (RX) 360 and antenna 370.

Although the scope of the present invention is not limited in this respect, memory 320 may include a FLASH memory, a non volatile memory, a volatile memory, a semiconductor memory and any memory device which may found by men skilled in the art to be implemented in embodiments of the present invention. Furthermore, antenna 370 may include an internal antenna, a dipole antenna, an antenna array, two or more antennas, a Yagi antenna and the like.

According to some embodiments of the invention, MAC 310 scans a wireless channel for an associated station (e,.g, station 124) and may establish a connection with a discovered station (e.g., station 124). MAC 310 may send a probe request to the associated station and may listen for a probe response from the associated station. The associated station (e.g., station 124) may send the probe response. RX 360 may receive the probe response from the associated station. MAC 310 may designate the associate station as a discovered station and store the discovered station in memory 320, if desired.

Furthermore, according to some embodiments of the invention, RX 360 may to receive the probe response from the associated station which includes information of a parking channel of the associated station. MAC 310 may store the received one or more parking channels 330 and may use the stored one or more parking channels to discover the associated one or more stations according to the parking channel 330 information. The information may include an availability of the station while parking on the parking channel, and MAC 310 may scan the associate station in a predetermined time intervals according to the availability of the station on its parking channel.

According to some embodiments of the present invention, MAC 310 may publish in the probe request frame its working channel 340 to the associated stations of the wireless network. It should be understood that the working channel of AP 300 is the channel where AP 300 sends a beacon signal and provides one or more services to the one or more associated stations of the wireless network (e.g., WLAN 100).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of establishing connection by an access point on a wireless local area network comprising:
scanning for discovering a station; and
establishing a connection with a discovered station.

2. The method of claim 1, wherein scanning comprises:
sending a probe request; and
listening to a probe response from said station.

3. The method of claim 2, further comprising:
receiving the probe response from said station; and
recording the station as the discovered station.

4. The method of claim 2, further comprising:
publishing in the probe request a working channel of the access point wherein the working channel is the channel where the access point sends a beacon signal and provides one or more services to the station.

5. The method of claim 2, further comprising:
receiving the probe response from said station wherein the probe response includes an information of a parking channel of the station; and
discovering the station according to the information.

6. The method of claim 5, wherein receiving the probe response further comprises:
receiving within the probe response an availability of the station while parking on the parking channel.

7. The method of claim 1, wherein scanning comprises:
scanning according to a predefined list of parking channels.

8. An access point comprising:
a medium access controller to scan a wireless channel for discovering a station and to establish a connection with a discovered station.

9. The access point of claim 8, wherein the medium access controller is able to send a probe request to the station and to listen for a probe response from the station.

10. The access point of claim 8, comprising:
a receiver to receive a probe response from the station; and
a memory to store the discovered station.

11. The access point of claim 9, wherein the medium access controller is able to publish in the probe request its working channel, wherein the working channel is the channel where the access point sends a beacon signal and provides one or more services to the station.

12. The access point of claim 10, the receiver is capable to receive the probe response from the station, wherein the probe response includes information of a parking channel of the station and the medium access controller is able to discover the station according to the information.

13. The access point of claim 10, wherein the probe response comprises information on availability of the station while parking on the parking channel.

14. The access point of claim 8, wherein the medium access controller is able to scan according to a predefined list of parking channels.

15. A wireless local area network comprising:
one or more stations capable of becoming a personal area network master device, wherein a station of the one or more stations includes a medium access controller to scan a wireless channel for discovering a station and to establish a connection with a discovered station.

16. The wireless local area network of claim 15, wherein the medium access controller of the station is able to send a probe request to the station and to listen for a probe response from the station.

17. The wireless local area network of claim 15, wherein the station comprises:
a receiver to receive a probe response from the station; and
a memory to store the discovered station.

18. The wireless local area network of claim 16, wherein the medium access controller of the station is able to publish in the probe request its working channel, wherein the working channel is the channel where the access point sends a beacon signal and provides one or more services to the station.

19. The wireless local area network of claim 17, wherein the receiver of the station is able to receive the probe response from the station, wherein the probe response includes information of a parking channel of the station and the medium access controller is able to discover the station according to the information.

20. The wireless local area network of claim 17, wherein the probe response comprises information on availability of the station while parking on the parking channel.

21. The wireless local area network of claim 15, wherein the medium access controller of the station is able to scan according to a predefined list of parking channels.
